(19) United States
(12) Patent Application Publication
(10) Pub. No.: US 2019/0295491 A1
(43) Pub. Date: Sep. 26, 2019

(54) VOLTAGE APPLYING CIRCUIT, DISPLAY DEVICE AND METHOD FOR APPLYING COMMON VOLTAGE SIGNAL

(71) Applicants: Beijing BOE Display Technology Co., Ltd., Beijing (CN); BOE TECHNOLOGY GROUP CO., LTD., Beijing (CN)

(72) Inventor: Wenshuai Song, Beijing (CN)

(21) Appl. No.: 16/169,890

(22) Filed: Oct. 24, 2018

(30) Foreign Application Priority Data
Mar. 23, 2018 (CN) 201810247117.8

(51) Int. Cl. G09G 3/36; G02F 1/1362

(52) U.S. Cl. CPC G09G 3/3696; G02F 1/1362; G09G 3/3688; G09G 3/3655

(57) ABSTRACT

The present disclosure provides a voltage applying circuit, a liquid crystal display device, and a method for applying a common voltage signal to a liquid crystal display panel. The voltage applying circuit includes: a control module, configured to output a control signal based on a gate low voltage signal of the display panel; and a switch module, configured to apply the common voltage signal to the liquid crystal display panel in response to the control signal.

### CROSS-REFERENCE

This application is based upon and claims priority to Chinese Patent Application No. 201810247117.8, filed on Mar. 23, 2018, the entire contents thereof are incorporated herein by reference.

### TECHNICAL FIELD

The present disclosure relates to the field of display technologies, and more particularly, to a voltage applying circuit, a liquid crystal display device, and a method for applying a common voltage signal to a liquid crystal display panel.

### BACKGROUND

A liquid crystal display is one of the most widely used flat panel displays. The liquid crystal display generally includes a liquid crystal layer arranged between two substrates, and displays an image by adjusting transmission of light by adjusting the state of the liquid crystal layer based on magnitude of an electric field applied to the liquid crystal layer.

However, there is a problem that the liquid crystal display flickers when it is turned on.

It is to be noted that the above information disclosed in this Background section is only for enhancement of understanding of the background of the present disclosure, and thus it may include information that does not constitute the prior art already known to those of ordinary skill in the art.

### SUMMARY

Arrangements of the present disclosure relate to a voltage applying circuit, a liquid crystal display device, and a method for applying a common voltage signal to a liquid crystal display panel.

According to an aspect of the present disclosure, there is provided a voltage applying circuit. The voltage applying circuit includes a control module configured to output a control signal based on a gate low voltage signal of the liquid crystal display panel. The voltage applying circuit includes a switch module configured to apply the common voltage signal to the liquid crystal display panel in response to the control signal.

According to the arrangements of the present disclosure, the switch module may include a PNP type triode and a first resistor. A first terminal of the first resistor is coupled to an emitter of the PNP type triode, a second terminal of the first resistor is coupled to a base of the PNP type triode. A base of the PNP type triode is configured to receive the control signal, the emitter of the PNP type triode is configured to receive the common voltage signal, and a collector of the PNP type triode is configured to output the common voltage signal.

According to the arrangements of the present disclosure, the first resistor may turn on the PNP type triode based on the common voltage signal and the control signal.

According to the arrangements of the present disclosure, the control module may include an NPN type triode, a second resistor, and a third resistor. A first terminal of the second resistor is coupled to an emitter of the NPN type triode and is configured to receive the gate low voltage signal. A second terminal of the second resistor, a first terminal of the third resistor and a base of the NPN type triode are coupled to one another. A collector of the NPN type triode is configured to output the control signal.

According to the arrangements of the present disclosure, the second resistor and the third resistor may turn on the NPN type triode based on the gate low voltage signal.

According to the arrangements of the present disclosure, a second terminal of the third resistor may be grounded.

According to the arrangements of the present disclosure, the voltage applying circuit may be a common voltage applying circuit configured to apply the common voltage signal to the liquid crystal display panel.

According to another aspect of the present disclosure, there is provided a liquid crystal display device. The liquid crystal display device includes a liquid crystal display panel and the above voltage applying circuit.

According to still another aspect of the present disclosure, there is provided a method for applying a common voltage signal to a liquid crystal display panel. According to the method, the above voltage applying circuit is employed to apply the common voltage signal to the liquid crystal display panel based on the gate low voltage signal.

### BRIEF DESCRIPTION OF THE DRAWINGS

The accompanying drawings are included to provide further understanding of the present disclosure. The accompanying drawings herein are incorporated in and constitute a part of this specification, illustrate arrangements of the present disclosure and, together with the description, serve to explain the principles of the present disclosure. Apparently, the accompanying drawings in the following show merely some arrangements of the present disclosure, and persons of ordinary skill in the art may still derive other drawings from these accompanying drawings without creative efforts. In the accompanying drawings:

FIG. 1 schematically illustrates a drive circuit of a pixel among a plurality of pixels of a liquid crystal display device;

FIG. 2 schematically illustrates a timing sequence of applying a common voltage and a gate low voltage when the liquid crystal display device is turned on;

FIG. 3 schematically illustrates a schematic diagram of a voltage applying circuit according to an exemplary arrangement of the present disclosure;

FIG. 4 schematically illustrates a circuit diagram of the voltage applying circuit according to an exemplary arrangement of the present disclosure; and

FIG. 5 schematically illustrates a timing sequence diagram of applying a common voltage signal and a gate low voltage signal when the liquid crystal display device is turned on according to an exemplary arrangement of the present disclosure.

### DETAILED DESCRIPTION

The exemplary arrangements of the present disclosure will now be described more fully with reference to the accompanying drawings. However, these arrangements can be implemented in a variety of forms and should not be construed as limited to the examples set forth herein. Rather, these arrangements are provided so that the present disclosure will be more thorough and complete and will fully convey the concepts of present disclosure to those skilled in the art. The features, structures, or characteristics described may be combined in one or more arrangements in any suitable manner.

It should be further understood that, phraseology “include” and/or “comprise” used in this specification refers to the presence of the characteristics, integers, steps, operations, elements and/or components, but not exclusive of the presence or addition of one or more other characteristics, integers, steps, operations, elements, components and/or groups thereof.

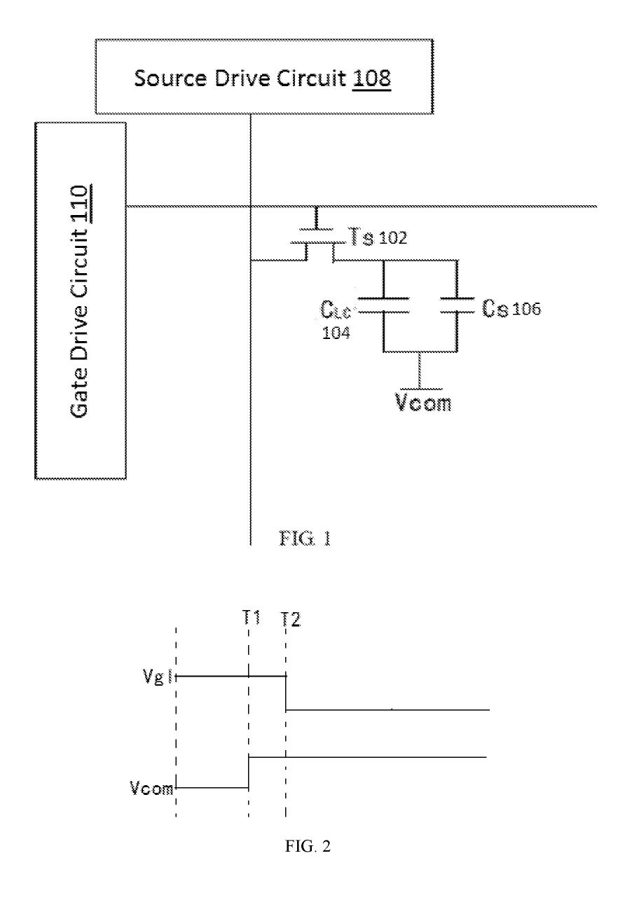

FIG. 1 schematically illustrates a drive circuit of a pixel among a plurality of pixels of a liquid crystal display device.

The liquid crystal display device includes a plurality of pixels. As shown in FIG. 1, the pixel typically includes a switch transistor Ts (102), a liquid crystal capacitor C_{LC} (104), and a storage capacitor Cs (106).

As a part of the pixel, the liquid crystal capacitor C_{LC} includes a common electrode and a pixel electrode formed on an upper substrate and a lower substrate of the liquid crystal display panel, and a liquid crystal layer arranged between the common electrode and the pixel electrode.

One terminal of the switch transistor Ts is connected to a source drive circuit 108 of the liquid crystal display device, the other terminal of the switch transistor Ts is connected to a pixel electrode of the liquid crystal capacitor C_{LC}, and a control terminal of the switch transistor Ts is connected to a gate drive circuit 110. Therefore, the switch transistor Ts is turned on when the gate drive circuit applies a gate high voltage signal to the switch transistor Ts, such that the source drive circuit charges the pixel electrode via the switch transistor Ts. The switch transistor Ts is turned off when the gate drive circuit applies a gate low voltage signal to the switch transistor Ts, such that the storage capacitor Cs maintains the voltage between the pixel electrode and the common electrode of the pixel. Liquid crystal molecules of the liquid crystal layer are deflected based on the voltage between the pixel electrode and the common electrode, such that light transmission of the liquid crystal molecules is changed to display the image.

However, the gate low voltage applied by the gate drive circuit and the common voltage Vcom applied to the common electrode have different generation mechanisms. Therefore, when the liquid crystal display device is turned on, the common voltage Vcom generally is applied to the common electrode earlier than the gate low voltage. For example, as shown in FIG. 2, when the liquid crystal display device is turned on, the common voltage Vcom is applied at time T1, and the gate low voltage Vgl is applied at time T2 later than T1, which causes the problem that the liquid crystal display device “flickers” when it is turned on.

Arrangements of the present disclosure relate to a voltage applying circuit, a liquid crystal display device, and a method for applying a common voltage signal to a liquid crystal display panel, which can solve the above problems to a certain extent.

In the following, the voltage applying circuit, the liquid crystal display device and the method for applying a common voltage signal to a liquid crystal display panel provided by the present disclosure will be described in detail with reference to the accompanying drawings and the exemplary arrangements.

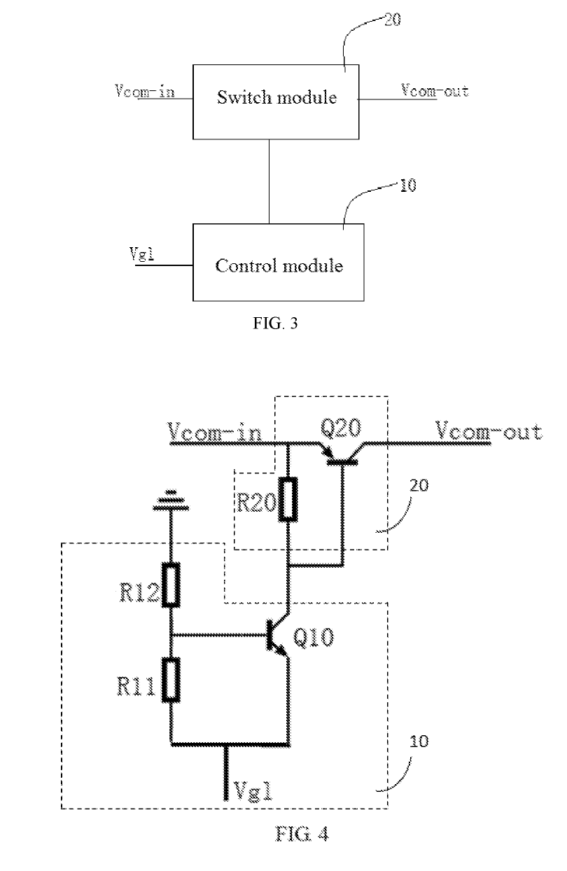

FIG. 3 illustrates a schematic diagram of a voltage applying circuit according to an exemplary arrangement of the present disclosure. According to the arrangements of the present disclosure, the voltage applying circuit may be a common voltage applying circuit configured to apply the common voltage signal to the liquid crystal display panel.

As shown in FIG. 3, the voltage applying circuit according to the arrangements of the present disclosure may include a control module 10 and a switch module 20.

The control module 10 may output a control signal based on a gate low voltage signal Vgl of the display panel. The gate low voltage signal Vgl here refers to a gate voltage applied to the liquid crystal display panel through a gate drive circuit such that a switch transistor of a pixel circuit of the liquid crystal display panel is turned off.

The switch module 20 may output the common voltage signal Vcom to the liquid crystal display panel in response to the control signal outputted from the control module 10, i.e., the common voltage signal Vcom is applied to a common electrode of the liquid crystal display panel. That is, the switch module 20 receives the common voltage signal Vcom outputted from, for example, a common voltage generating circuit of the liquid crystal display device (i.e., common voltage input Vcom-in), and applies the common voltage signal Vcom to the liquid crystal display panel in response to the control signal outputted from the control module 10 (i.e., common voltage output Vcom-out).

As mentioned above, the voltage applying circuit according to the arrangements of the present disclosure may control outputting of the common voltage signal Vcom to the liquid crystal display panel by applying the gate low voltage signal Vgl, such that the common voltage signal Vcom may be applied to the liquid crystal display panel later than the gate low voltage signal Vgl. Therefore, the voltage applying circuit of the present disclosure may solve the problem that the liquid crystal display device flickers because the common voltage signal is applied to the liquid crystal display panel earlier than the gate low voltage signal when the liquid crystal display device is turned on.

FIG. 4 illustrates a circuit diagram of the voltage applying circuit of FIG. 3 according to the exemplary arrangements of the present disclosure.

As shown in FIG. 4, according to the exemplary arrangements of the present disclosure, the switch module 20 may include a PNP type triode Q20 and a first resistor R20. One terminal of the first resistor R20 is coupled to an emitter of the PNP type triode Q20, and the other terminal of the first resistor R20 is coupled to a base of the PNP type triode Q20. The base of the PNP type triode Q20 receives the control signal outputted from the control module 10, the emitter of the PNP type triode Q20 receives the common voltage signal Vcom, and a collector of the PNP type triode Q20 outputs the common voltage signal Vcom to the liquid crystal display panel.

According to the exemplary arrangements of the present disclosure, the first resistor R20 may be configured to turn on the PNP type triode Q20 based on the common voltage signal Vcom and voltage of the control signal. In this case, the PNP type triode Q20 actually is turned on based on the applied control signal because the common voltage signal Vcom is applied to the PNP type triode Q20 earlier than the control signal.

According to the exemplary arrangements of the present disclosure, the control module 10 may include an NPN type triode Q10, a second resistor R11, and a third resistor R12. One terminal of the second resistor R11 is coupled to an emitter of the NPN type triode Q10 and is configured to receive the gate low voltage signal Vgl, the other terminal of the second resistor R11, one terminal of the third resistor R12 and a base of the NPN type triode Q10 are coupled to one another, and a collector of the NPN type triode Q10 outputs the control signal.

According to the exemplary arrangements of the present disclosure, the second resistor R11 and the third resistor R12 may be configured to turn on the NPN type triode Q10 based on voltage of the gate low voltage signal Vgl. Here, the other terminal of the third resistor R12 may be grounded. However, the present disclosure is not limited thereto. Any voltage may be applied to the other terminal of the third resistor R12, as long as it can be ensured that the second resistor R11 and the third resistor R12 may turn on the NPN type triode Q10 based on the gate low voltage signal Vgl.

As shown in FIG. 4, in the voltage applying circuit according to the exemplary arrangements of the present disclosure, when the liquid crystal display device is turned on, before the gate low voltage signal Vgl is applied to the liquid crystal display panel, i.e., before the gate low voltage signal Vgl is pulled down, the base current of the NPN type triode Q10 is 0, and no voltage is applied to two terminals of the first resistor R20, and thus the PNP type triode Q20 is in an off state. At this moment, even though the common voltage signal Vcom has been applied to the voltage applying circuit, the voltage applying circuit cannot output the common voltage signal Vcom to the liquid crystal display panel.

When the gate low voltage signal Vgl is applied to the liquid crystal display panel, i.e., after the gate low voltage signal Vgl is pulled down, the base of the NPN type triode Q10 generates electric current, and electric current of the collector of the NPN type triode Q10 flows through the first resistor R20, such that voltage (for example, about 0.7V) driving the PNP type triode Q20 to work in a saturation region is generated at two terminals of the first resistor R20, and thus the PNP type triode Q20 is turned on. Therefore, the common voltage signal Vcom is outputted to the liquid crystal display panel via the voltage applying circuit according to the exemplary arrangements of the present disclosure.

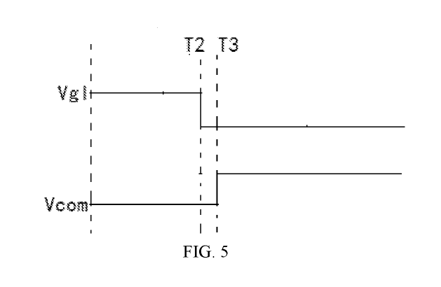

As can be seen from the above description, the voltage applying circuit according to the arrangements of the present disclosure may control outputting of the common voltage signal Vcom to the liquid crystal display panel by applying the gate low voltage signal Vgl, such that the common voltage signal Vcom may be applied to the liquid crystal display panel later than the gate low voltage signal Vgl. FIG. 5 illustrates a timing sequence diagram of applying the common voltage signal and the gate low voltage signal when the liquid crystal display device is turned on according to the arrangements of the present disclosure. As shown in FIG. 5, the gate low voltage signal Vgl is applied to the liquid crystal display panel at time T2, and the common voltage signal Vcom is applied to the liquid crystal display panel at time T3 later than the time T2. Therefore, the voltage applying circuit of the present disclosure may solve the problem that the liquid crystal display device flickers due to that the common voltage signal is applied to the liquid crystal display panel earlier than the gate low voltage signal when the liquid crystal display device is turned on.

According to the exemplary arrangements of the present disclosure, there is further provided a liquid crystal display device. The liquid crystal display device includes a liquid crystal display panel and the above voltage applying circuit. The voltage applying circuit applies the common voltage signal to the liquid crystal display panel. Specifically, the voltage applying circuit may be coupled between the common voltage generating circuit of the liquid crystal display device and the common electrode of the liquid crystal display panel to apply the common voltage signal to the liquid crystal display panel under the control of the gate low voltage signal.

As mentioned above, for the liquid crystal display device according to the arrangements of the present disclosure, its voltage applying circuit may control outputting of the common voltage signal Vcom to the liquid crystal display panel by applying the gate low voltage signal Vgl, such that the common voltage signal Vcom may be applied to the liquid crystal display panel later than the gate low voltage signal Vgl. Therefore, it may solve the problem that the liquid crystal display device flickers due to the common voltage signal is applied to the liquid crystal display panel earlier than the gate low voltage signal when the liquid crystal display device is turned on.

Furthermore, according to the exemplary arrangements of the present disclosure, there is further provided a method for applying a common voltage signal to a liquid crystal display panel. According to the method, the common voltage signal is applied to the liquid crystal display panel based on the applying of the gate low voltage signal. The common voltage signal is applied to the liquid crystal display panel based on the applying of the gate low voltage signal, such that the common voltage signal Vcom may be applied to the liquid crystal display panel later than the gate low voltage signal Vgl. Therefore, it may solve the problem that the liquid crystal display device flickers due to that the common voltage signal is applied to the liquid crystal display panel earlier than the gate low voltage signal when the liquid crystal display device is turned on.

The foregoing description of the particular exemplary arrangements of the present disclosure has been given with reference to the accompanying drawings. These exemplary arrangements are not intended to be exhaustive or limit the present disclosure to be the disclosed exact construction, and apparently, various modifications and changes can be made by those of ordinary skill in the art under the enlightenment the above teachings. Therefore, the scope of the present disclosure is not intended to be restricted to the foregoing arrangements but is intended to be limited by the claims and their equivalents.

What is claimed is:

1. A voltage applying circuit, comprising:
a control module, configured to output a control signal based on a gate low voltage signal of a liquid crystal display panel; and
a switch module, configured to apply a common voltage signal to the liquid crystal display panel in response to the control signal.

2. The voltage applying circuit according to claim 1, wherein the switch module comprises a PNP type triode and a first resistor,
wherein a first terminal of the first resistor is coupled to an emitter of the PNP type triode, and a second terminal of the first resistor is coupled to a base of the PNP type triode, and
wherein the base of the PNP type triode is configured to receive the control signal, the emitter of the PNP type triode is configured to receive the common voltage signal, and a collector of the PNP type triode is configured to output the common voltage signal.

3. The voltage applying circuit according to claim 2, wherein the first resistor is configured to turn on the PNP type triode based on the common voltage signal and the control signal.

4. The voltage applying circuit according to claim 1, wherein the control module comprises an NPN type triode, a second resistor, and a third resistor,
wherein a first terminal of the second resistor is coupled to an emitter of the NPN type triode and is configured to receive the gate low voltage signal, a second terminal of the second resistor, a first terminal of the third resistor and a base of the NPN type triode are coupled to one another, and a collector of the NPN type triode is configured to output the control signal.

5. The voltage applying circuit according to claim 4, wherein the second resistor and the third resistor are configured to turn on the NPN type triode based on the gate low voltage signal.

6. The voltage applying circuit according to claim 5, wherein a second terminal of the third resistor is grounded.

7. The voltage applying circuit according to claim 2, wherein the control module comprises an NPN type triode, a second resistor, and a third resistor,
wherein a first terminal of the second resistor is coupled to an emitter of the NPN type triode and is configured to receive the gate low voltage signal, a second terminal of the second resistor, a first terminal of the third resistor and a base of the NPN type triode are coupled to one another, and a collector of the NPN type triode is configured to output the control signal.

8. The voltage applying circuit according to claim 7, wherein the second resistor and the third resistor are configured to turn on the NPN type triode based on the gate low voltage signal.

9. The voltage applying circuit according to claim 8, wherein a second terminal of the third resistor is grounded.

10. The voltage applying circuit according to claim 1, wherein the voltage applying circuit is a common voltage applying circuit configured to apply the common voltage signal to the liquid crystal display panel.

11. A liquid crystal display device, comprising a liquid crystal display panel and a voltage applying circuit, wherein the voltage applying circuit comprises:
a control module, configured to output a control signal based on a gate low voltage signal of a liquid crystal display panel; and
a switch module, configured to apply a common voltage signal to the liquid crystal display panel in response to the control signal.

12. The liquid crystal display device according to claim 11, wherein the switch module comprises a PNP type triode and a first resistor,
wherein a first terminal of the first resistor is coupled to an emitter of the PNP type triode, and a second terminal of the first resistor is coupled to a base of the PNP type triode, and
wherein the base of the PNP type triode is configured to receive the control signal, the emitter of the PNP type triode is configured to receive the common voltage signal, and a collector of the PNP type triode is configured to output the common voltage signal.

13. The liquid crystal display device according to claim 12, wherein the first resistor is configured to turn on the PNP type triode based on the common voltage signal and the control signal.

14. The liquid crystal display device according to claim 11, wherein the control module comprises an NPN type triode, a second resistor, and a third resistor,
wherein a first terminal of the second resistor is coupled to an emitter of the NPN type triode and is configured to receive the gate low voltage signal, a second terminal of the second resistor, a first terminal of the third resistor and a base of the NPN type triode are coupled to one another, and a collector of the NPN type triode is configured to output the control signal.

15. The liquid crystal display device according to claim 14, wherein the second resistor and the third resistor are configured to turn on the NPN type triode based on the gate low voltage signal.

16. The liquid crystal display device according to claim 15, wherein a second terminal of the third resistor is grounded.

17. The liquid crystal display device according to claim 12, wherein the control module comprises an NPN type triode, a second resistor, and a third resistor,
wherein a first terminal of the second resistor is coupled to an emitter of the NPN type triode and is configured to receive the gate low voltage signal, a second terminal of the second resistor, a first terminal of the third resistor and a base of the NPN type triode are coupled to one another, and a collector of the NPN type triode is configured to output the control signal.

18. The liquid crystal display device according to claim 17, wherein the second resistor and the third resistor are configured to turn on the NPN type triode based on the gate low voltage signal.

19. The liquid crystal display device according to claim 18, wherein a second terminal of the third resistor is grounded.

20. The liquid crystal display device according to claim 11, wherein the voltage applying circuit is a common voltage applying circuit configured to apply the common voltage signal to the liquid crystal display panel.
